(19) United States
(12) Patent Application Publication
(10) Pub. No.: US 2003/0028425 A1
(43) Pub. Date: Feb. 6, 2003

(54) Method for increasing patronage to a sales enterprise through utilizing an award system

(76) Inventors: Adam S. Zane, Camarillo, CA (US); Stephanie L. Zane, Camarillo, CA (US); Jon M. Landa, Los Angeles, CA (US); Robyn S. Meisinger, Los Angeles, CA (US)

Correspondence Address: OPPENHEIMER WOLFF & DONNELLY LLP, 2029 Century Park East, 38th Fl., Los Angeles, CA, 90067, US

(21) Appl. No.: 09/919,137

(22) Filed: Jul. 31, 2001

(51) Int. Cl. G06F 17/60

(52) U.S. Cl. 705/14

(57) ABSTRACT

A method for generating customer traffic into a retail establishment utilizing an award program wherein a student accompanied by a parent or guardian delivers the student's grade report sheet to the establishment. The grades from the grade report sheet are mapped to corresponding numbers representing purchase credits, which are subsequently converted to a cash equivalent amount. The cash equivalent amount is credited to the purchase of a product by the student or the guardian when the purchase credits are redeemed in person by an adult at the retail establishment.

### BACKGROUND OF THE INVENTION

1. Field of the Invention

The present invention relates to a system and method for increasing customer traffic into an enterprise through use of a method of awarding points to a targeted demographic for redemption at the location of the enterprise.

The present invention relates more particularly to a system and method for increasing customer traffic into an enterprise through use of a method of awarding points to young people, based on their grades in school, for redemption at a retail store such as an automotive dealership, wherein at least one parent or guardian is required to accompany the student into the retail establishment.

2. General Background and State of the Art

Typically, incentive programs are developed by enterprises to develop and promote customer loyalty. These incentive programs generally include coupons for rebates or discounts on specific products. Many enterprises distribute these coupons through a point-of-sale or by a mail-order system. For example, in the case of a point-of-sale system, the store clerk issues a coupon when a customer purchases a product at a store. Depending on the information provided on the coupon, the customer mails the coupon to the enterprise for obtaining a rebate on the purchase. Alternatively, the customer may be prompted to log on to a specific web-site on the Internet for redeeming the coupon.

### SUMMARY OF THE INVENTION

There are several disadvantages to an approach as described above. Firstly, a problem with the point-of-sale system is that the rebate (award) system does not encourage the customer to know the enterprise that is issuing the rebate, since the customer has to simply mail in the rebate. Thus, the much touted customer loyalty may be solely superficial and limited in scope to the rebate. Secondly, when a customer logs on to an Internet web-site to redeem the coupon, the product display on the web-site may not provide a “feel” for the products that may be of interest to the customer. This may reduce the probability of the customer purchasing another product. Also, there needs to be a better system for inducing a customer or prospective customer to return to the seller's venue, so that the seller has multiple opportunities to show its wares to the customer and solicit a purchase by the customer.

Thus, what is needed is the following: (i) a program that induces the customer to “know” the enterprise's product line, (for example, by generating repeated “customer traffic” into the enterprise's retail establishment), (ii) a program that generates goodwill in the community thereby promoting customer awareness and loyalty, (iii) a program that builds pride and self-esteem of the participants, which becomes associated with the goods and/or services of the enterprise, in turn creating a favorable impression in the mind of the customer, and (iv) a program that is sensible and fair, which again increases the goodwill in the offerings of the enterprise, making it easier for the enterprise to sell its goods and services.

In one embodiment of the present invention an award system is described, wherein a minor student, upon receiving her grades, accompanies at least one of her parents or her adult guardian to a retail store, such as an automobile dealership, to deliver her grade report. The store owner/dealer computes the total points earned by the student for those grades depending upon a predetermined mapping scheme that maps the grades to a point allocation table. The points are entered onto a pre-printed point allocation table at the dealership, and printed on a card. An updated copy of the point allocation table is handed back to the student, and another copy of the same table is forwarded to the headquarters of the automobile manufacturer or product manufacturer. The points in the point allocation table are converted into an explicit cash amount based on a point to cash mapping scheme. This updated cash amount is then stored in the student and/or parent/guardian information database at the headquarters. A copy of this update is either mailed to the student, provided on a web-site for retrieval by the student, or incorporated in an automated telephone system. This cash amount can subsequently be used as a credit towards the purchase of a product, such as an automobile, by the student or her parents. Alternatively, the cash amount can be refunded to the student upon purchase of the product. As a major advantage to this system, the parent or guardian accompanying the student will have an opportunity to browse through the products/automobiles in the enterprise. This may pique the interest of the parent or guardian to purchase an automobile, thereby increasing the profitability of the product manufacturer and the dealer. It will also provide an opportunity to the sales staff to directly solicit a purchase by the adult. Therefore, the presence of the parent or guardian increases the “foot traffic” to the automobile dealership/retail store, thereby potentially adding to the sales.

In another embodiment of the present invention, a student, upon receiving her grades, accompanies her parent or guardian to deliver the grade sheet to a retail store such as an automobile dealership. The store owner/dealer computes the total points earned by the student for those grades depending upon a predetermined mapping scheme that maps the grades to a point allocation table. The store/dealership also maps the points in the point allocation table to an explicit cash amount, based on a point to cash mapping scheme. This local update mechanism reduces the amount of data flowing between the store/dealership and the automobile/product manufacturer headquarters, thereby minimizing transportation and processing times. This allows the student to instantly redeem the cash amount towards the purchase of a product/automobile at the store/dealership upon presentation of the grade sheet. As an added advantage to this scheme, the parent or guardian accompanying the student also get an opportunity to browse through the products/automobiles in the store/dealership. This may pique the interest of the parent or guardian to make an investment into purchasing another product/automobile, thereby increasing the profitability of the product manufacturer and the storeowner. The presence of the guardian or parent essentially increases the “foot traffic” to the automobile dealership/retail store, thereby potentially adding to the sales of the store.

### BRIEF DESCRIPTION OF THE DRAWINGS

In order that the manner in which the above-recited advantages and objects of the invention are attained, as well as others which will become apparent, a more particular description of the invention briefly summarized above is described below and illustrated in the appended drawings. It is to be understood, however, that the appended drawings illustrate only typical embodiments of the invention and are therefore not to be considered limiting of its scope, for the invention may admit to other equally effective embodiments.

In the drawings:

FIG. 1 is an exemplary depiction of a point allocation table. Each letter grade in the table is mapped to a specific number of points;

FIG. 2 is another exemplary depiction showing a nonlinear plot mapping a grade point average (GPA) to a specific number of points;

FIG. 3 is a plot depicting a linear mapping from the number of points to the equivalent cash amount; and

FIG. 4 is the flow chart of the overall process for obtaining a cash credit towards the purchase of an automobile.

### DETAILED DESCRIPTION OF PREFERRED EMBODIMENTS OF THE INVENTION

As an example of a situation occurring within the parameters of the preferred embodiment of this invention, a student, upon receiving her grade sheet, accompanies her parents to an automobile dealership with her grade sheet. The adults view the merchandise in the dealership, and the sales staff has an opportunity to present information to the adults, and solicit a purchase. During this visit, the grades are converted into markers such as numbers, letters, points, etc. which are mapped to a cash equivalent amount for subsequent credit towards an automobile purchase. Before going to the dealership, the student or parents may compute the cash amount that will be credited to the student upon presentation of the grade sheet to the dealer. A time limit may be placed on how long a student and accompanying adult may wait until presenting the grade sheet. The time period may be short, perhaps one month, to encourage quick redemption, or very long, perhaps one year, to allow the adults maximum flexibility. Depending upon the enterprise, varying allowable presentation periods may be chosen.

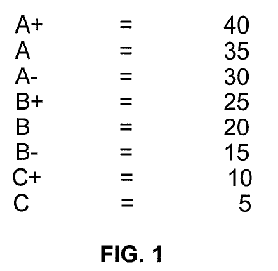

FIG. 1 shows an exemplary depiction of a point allocation table. In this table, the letter grade is converted into a predetermined number of points. Thus, for example, a student obtaining a grade of an A+ is entitled to receive 40 points, whereas the number of points are reduced to 20 upon receiving a grade of B. The points for each grade are added up to yield a net point score for the grade sheet.

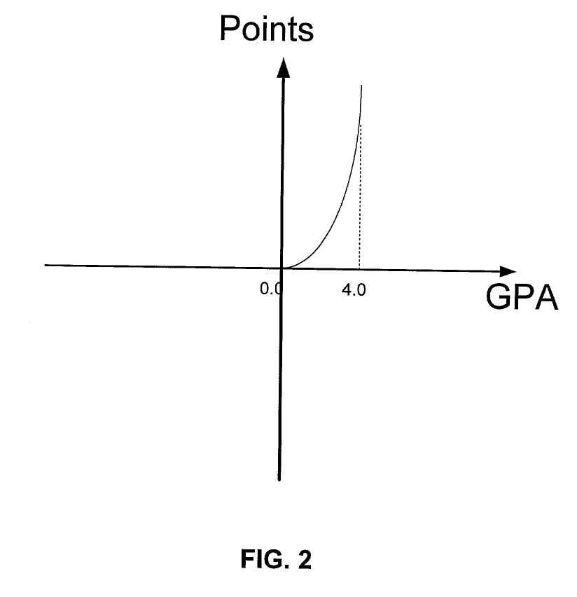

An alternative mechanism for computing the points in the point allocation table is shown in FIG. 2. The mapping scheme in this case is the nonlinear squashing function, y=tanh(g*x), where x is the grade point average (GPA) for the grade sheet, y is the number of points for the grade sheet, and g is the gain controlling the slope of the squashing function.

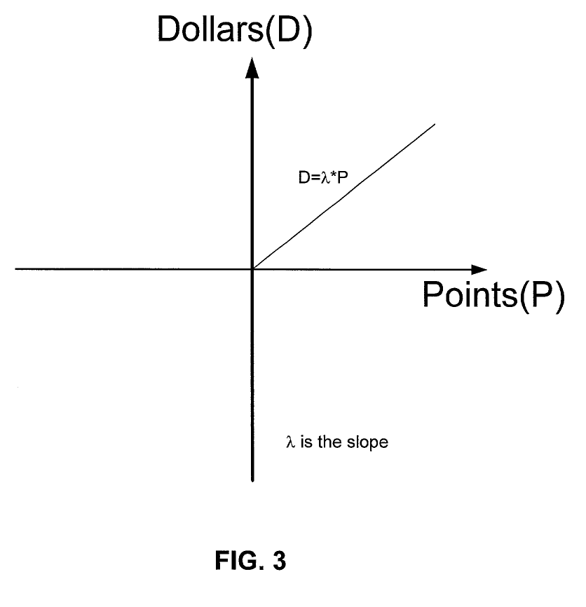

In one embodiment, upon determining the total number of points for the grade sheet, the dealer enters or updates the points in a card that is made exclusively for the student. A copy of this card is presented to the student for her records, and another copy is mailed to the automobile manufacturer headquarters. At the headquarters, the points are mapped to a cash amount by a pre-determined lookup table or a mapping function. An example of such a mapping function is shown in FIG. 3.

The cash amount is credited to a student's account within a database stored in a server at the headquarters. A statement pertaining to this account is either mailed to the student or made available to the student at a web-site on the Internet. Alternatively, the enterprise may make it a requirement that at least one parent or guardian personally visit the enterprise to retrieve the statement, giving the adult another view of the offerings of the enterprise, whether goods or services, and another opportunity for the sales staff to solicit the purchase of goods or services. Included within the statement is information pertaining to the cash amount available to the student as a credit or refund towards the purchase of an automobile. Based on this information, the student, with at least one parent or guardian, may go directly to the dealership to redeem the cash amount towards purchase of an automobile. Upon the purchase of an automobile, the student's point account is re-initialized to zero until she, along with a parent or guardian, delivers the next grade report to the dealership.

In another embodiment, a student, upon receiving her grades, accompanies her parent or guardian to an automobile dealership with her grade sheet. The adults view the merchandise in the dealership, and the sales staff has an opportunity to present information to the adults, and solicit a purchase. During this visit, the dealer computes the total points earned by the student for those grades depending upon a predetermined mapping scheme that maps the grades to a point allocation table. The dealership also maps the points in the point allocation table to an explicit cash amount, based on a point to cash mapping scheme. This local update mechanism reduces the amount of data flowing between the dealership and the automobile manufacturer headquarters, thereby minimizing transportation and processing times. This allows the student and parent/guardian to instantly redeem the cash amount towards the purchase of an automobile at the dealership upon presentation of the grade sheet. Subsequently, for verification purposes, a copy of the grade sheet is sent to the automobile manufacturer headquarters.

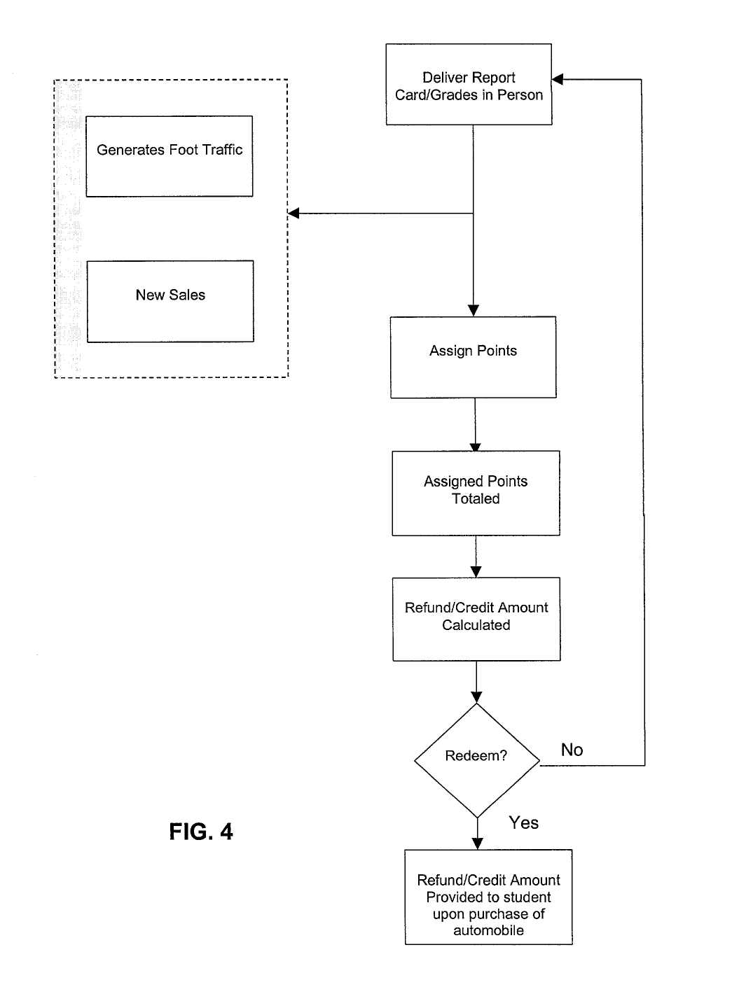

FIG. 4 is the flow chart of the overall process for obtaining a cash credit towards the purchase of an automobile.

While the specification describes particular embodiments of the present invention, those of ordinary skill can devise variations of the present invention without departing from the inventive concept.

We claim:

1. A method for implementing an award program in a retail store, the method comprising:
obtaining a grade report sheet from a student, said student being accompanied by at least a guardian;
mapping a grade from said grade report sheet to a number; and
converting the number to a cash amount.

2. The method according to claim 1, further including the step of crediting the cash amount to the student for purchase of a retail product, the credit for the cash amount being provided by the product manufacturer.

3. The method according to claim 1, further including the step of entering the number into a pre-printed point allocation table for updating said pre-printed point allocation table.

4. The method according to claim 3, wherein a copy of the updated pre-printed point allocation table is provided to the student.

5. The method according to claim 3, wherein a copy of the updated pre-printed point allocation table is provided to a manufacturer providing the product for sale.

6. The method according to claim 5, wherein the step of converting the number into a cash amount is performed at the headquarters of the manufacturer providing the product for sale.

7. The method according to claim 6, wherein the cash amount and student information is stored in an information database on a computer at the headquarters of the manufacturer providing the product for sale.

8. The method according to claim 1, further including the step of refunding the cash amount to the student upon purchase of a product.

9. The method according to claim 1, wherein said mapping is a linear mapping;

10. The method according to claim 1, wherein said mapping is a nonlinear mapping.

11. A method for implementing an award program for an automobile purchase, the method comprising:
obtaining a grade report sheet from a student at an automobile dealership, said student being accompanied by at least a guardian;
mapping a grade from said grade report sheet to a number at the dealership;
converting the number to a cash amount at the dealership; and
providing a rebate, corresponding to the cash amount, by a dealer at the dealership for the purchase of an automobile by the student at said dealership.

12. The method according to claim 11, further including the step of entering the number into a pre-printed point allocation table for updating said pre-printed point allocation table.

13. The method according to claim 11, wherein a copy of the updated pre-printed point allocation table is provided to the student.

14. The method according to claim 11, wherein a copy of the updated pre-printed point allocation table is provided to a manufacturer of the automobile.

15. The method according to claim 11, wherein the cash amount and student information is stored in an information database on a computer at the dealership.

16. The method according to claim 11, wherein the rebate is a cash refund.

17. The method according to claim 11, wherein said mapping is a linear mapping;

18. The method according to claim 11, wherein said mapping is a nonlinear mapping.

19. The method according to claim 11, wherein a copy of the grade report is sent to the headquarters of a manufacturer of the automobile.

20. The method according to claim 11, wherein the grade is a letter grade.

21. The method according to claim 11, where the grade is a grade point.

22. A method for generating customer traffic into a retail establishment, the method comprising:
delivering a grade report sheet of a student to the establishment, said student being accompanied by at least one adult guardian;
mapping a grade from said grade report sheet to a number;
converting the number to a cash amount; and
crediting the cash amount to either of the student or the guardian upon purchase of a product by the student or the guardian.

23. The method according to claim 22, further including the step of entering the number into a pre-printed point allocation table for updating said pre-printed point allocation table.

24. The method according to claim 23, wherein a copy of the updated pre-printed point allocation table is provided to the student.

25. The method according to claim 23, wherein a copy of the updated pre-printed point allocation table is provided to a manufacturer providing the product for sale.

26. The method according to claim 22, wherein the step of converting the number into a cash amount is performed at the headquarters of the manufacturer providing the product for sale.

27. The method according to claim 26, wherein the cash amount, student information and/or guardian information is stored in an information database on a computer at the headquarters of the manufacturer providing the product for sale.

28. The method according to claim 22, wherein said mapping is a linear mapping;

29. The method according to claim 22, wherein said mapping is a nonlinear mapping.

30. A method for generating adult traffic into an enterprise, the method comprising:
encouraging the physical delivery of a grade report sheet of a student to the enterprise, the grade report sheet being accompanied by an adult;
mapping a grade from said grade report sheet to a marker;
converting the marker to a cash equivalent amount; and
crediting the cash equivalent amount to a purchase.

31. The method of claim 30 wherein the adult is a parent of the student.

32. The method of claim 30 wherein the adult is a guardian of the student.

33. The method of claim 30 further comprising:
requiring the physical presence of an adult at the enterprise to obtain the crediting of the cash equivalent amount to a purchase.

34. A method for generating adult traffic into an enterprise, the method comprising:
requiring the physical delivery of a grade report sheet of a student to the enterprise, the grade report sheet being accompanied by an adult;
mapping a grade from said grade report sheet to a marker;
converting the marker to a cash equivalent amount;
crediting the cash equivalent amount to a purchase; and
requiring the physical presence of an adult at the enterprise to obtain the crediting of the cash equivalent amount to a purchase.

35. The method of claim 30 further comprising:
maintaining a database of cash equivalent amounts at the enterprise.

36. The method of claim 30 further comprising:
encouraging the physical delivery of at least a second grade report sheet of a student to the enterprise by an adult;
mapping a grade from said at least second grade report sheet to a marker;
converting the marker to a second cash equivalent amount;
summing the plurality of cash equivalent amounts;
crediting at least a portion of the summed cash equivalent amount to a purchase; and
requiring the physical presence of an adult at the enterprise to obtain the crediting of the cash equivalent amount to a purchase;

37. The method of claim 36 wherein the enterprise includes of a plurality of locations displaying a common trademark.

38. The method of claim 36 wherein the enterprise is an automobile manufacturer.

39. The method of claim 37 wherein the locations are automobile dealerships.

40. The method of claim 37 further comprising:
maintaining a database of cash equivalent amounts, said database including information from at least one of the plurality of locations.

41. The method of claim 36 wherein the grade sheet must have issued no later than one month prior to presentation.

42. The method of claim 36 wherein the grade sheet must have issued no later than one year prior to presentation.

43. A method for generating adult traffic into an enterprise, the method comprising:
the enterprise receiving a physical delivery of a grade report sheet of a student, the grade report sheet being accompanied by an adult;
representing at least one grade on the grade report sheet as a cash equivalent amount, the cash equivalent amount applicable as a credit toward a purchase; and
crediting at least a portion of the cash equivalent amount to a purchase at the request of an adult physically present at the enterprise.
